(19) United States
(12) Patent Application Publication
(10) Pub. No.: US 2026/0217868 A1
(43) Pub. Date: Jul. 30, 2026

(54) Preparation Method for Cellulose-based Texture Modifier and Stabilizing Agent Extracted with Deep Eutectic Solvent

(71) Applicant: JIANGNAN UNIVERSITY, Wuxi (CN)

(72) Inventors: Fang ZHONG, Wuxi (CN); Zhe YU, Wuxi (CN); Fei LIU, Wuxi (CN); Ling CHEN, Wuxi (CN); Maoshen CHEN, Wuxi (CN)

(21) Appl. No.: 19/453,541

(22) Filed: Jan. 20, 2026

(30) Foreign Application Priority Data
Jan. 24, 2025 (CN) 202510114355.1

(51) Int. Cl. C08B 1/00

(52) U.S. Cl. CPC C08B 1/003

(57) ABSTRACT

The present invention discloses a cellulose-based texture modifier and stabilizing agent extracted with a deep eutectic solvent and a preparation method, comprising the following steps: preparation of a deep eutectic solvent, raw material pretreatment, heating extraction, filter pressing, washing, defibering and drying. The deep eutectic solvent extraction method in the present invention is simple and feasible, and can efficiently defiber cellulose in the presence of lignin, thus avoiding pollution that may be caused by other chemical methods when removing lignin.

### CROSS-REFERENCE TO RELATED APPLICATIONS

The present application claims priority to Chinese Patent Application No. 202510114355.1, filed on Jan. 24, 2025, the entire disclosure of which is incorporated herein by reference.

### TECHNICAL FIELD

The present invention belongs to the technical field of comprehensive biomass application, and in particular relates to a preparation method for a cellulose-based texture modifier and stabilizing agent extracted with a deep eutectic solvent.

### BACKGROUND

Non-wood-derived cellulose-based biomass, such as herbaceous plants and straws, contains a large amount of short fibers due to cell composition and structural characteristics. Such property not only limits the application in traditional fields such as papermaking, but also poses challenges to the pretreatment process in other new material fields, such as the preparation of nanocellulose. In addition, cellulose-based biomass usually contains a large amount of lignin and hemicellulose in addition to cellulose. The lignin is of a complex structure. The main structural units include phenylpropenols (such as vanillyl alcohol and guaiacol), which are connected by strong chemical bonds such as phenolic ether bonds and ether bonds. Even pretreatment under strong acid or alkali conditions cannot completely break these chemical bonds. The difficulty of lignin removal and the inhibition of subsequent processing of cellulose have also become a major difficulty in biomass utilization.

At present, the utilization of cellulose-based biomass is usually to separate hemicellulose, lignin and cellulose and use separately. Hemicellulose is usually used for hydrolysis to produce ethanol or monosaccharides and derivatives; cellulose is also widely used in the preparation of biofuels or nanocellulose; and lignin is still in the development stage of efficient utilization. Separation of the three elements of non-lignocellulosic biomass is still high in cost at present, facing many challenges in large-scale commercialization due to inconsistent fiber lengths. A simple and low-cost method is urgently needed to treat cellulose-based biomass without considering lignin removal and obtain good commercial application results.

In the field of commercial cellulose-based texture modifier, the current common products include colloidal microcrystalline cellulose, citrus fiber, and the like. The key to the effect is that a hydroxyl structure rich in cellulose can form hydrogen bonds with water and form a hydrogen bond network at a certain concentration, thus providing excellent viscoelastic and gel structures. The strength of the hydrogen bond network is mainly determined by the amount of hydroxyl groups that can participate in hydration in cellulose. Can this efficiency will be further improved by enhancing the cellulose hydrogen bond network without completely removing lignin?

Deep eutectic solvent is a liquid solvent formed by two or more components (usually including a hydrogen bond donor and a hydrogen bond acceptor) through eutectic reaction. Due to the strong hydrogen bond interaction between the components, the eutectic has a melting point usually lower than the melting point of a single component, and is even at a liquid state at room temperature. Studies have shown that it can defiber cellulose in the presence of lignin, and can remove hemicellulose and part of lignin, showing great application potential in fields such as biomass conversion.

In summary, the difficulty in removing lignin and the poor consistency of fibers are two important technical difficulties in realizing commercial application of cellulose-based biomass. The present invention provides a cellulose-based texture modifier and stabilizing agent extracted with a deep eutectic solvent and a preparation method. The efficiency of the innovated product is better than that of a variety of commercially available agents, and the effect can still be exerted in the case of more lignin residues and poor consistency of fiber particle size.

### SUMMARY

The purpose of the section is to overview some aspects of embodiments of the present invention and to briefly introduce some of preferable embodiments. In the section as well as in the abstract and title of the present application, some simplifications or omissions may be made to avoid making the purpose of the section, the abstract and the title ambiguous, but such simplifications or omissions cannot be used to limit the scope of the present invention.

The present invention is provided in view of the above problems or the problems in the prior art.

Therefore, one purpose of the present invention is to overcome disadvantages of the prior art, and provides a preparation method for a cellulose-based texture modifier and stabilizing agent extracted with a deep eutectic solvent.

In order to solve the above technical problems, the present invention provides the following technical solutions, including,
mixing a hydrogen bond donor, a hydrogen bond acceptor and water, and heating to prepare a deep eutectic solvent; mixing the deep eutectic solvent with a cellulose raw material, and performing heating extraction; and performing filter pressing, washing, suction filtration, defibering, and drying on the extracted cellulose raw material, thereby obtaining a cellulose-based agent.

As a preferable solution of the preparation method for the cellulose-based texture modifier and stabilizing agent extracted with the deep eutectic solvent, the hydrogen bond donor includes one or more of amino compounds, polycarboxylic acids, polyhydric alcohol compounds or compounds with both amino groups and carboxyl groups; and the hydrogen bond acceptor includes one or more of ammonium chloride, sodium chloride and choline chloride.

As a preferable solution of the preparation method for the cellulose-based agent extracted with the deep eutectic solvent, the amino compounds include urea; the polycarboxylic acids include acetic acid, oxalic acid, citric acid, tartaric acid, lactic acid, malic acid and phenylacetic acid; the polyhydric alcohol compounds include glycerol, glycol and propylene glycol; and the compounds with both amino groups and carboxyl groups include glycine and glutamic acid.

As a preferable solution of the preparation method for the cellulose-based texture modifier and stabilizing agent extracted with the deep eutectic solvent, the mole ratio of the hydrogen bond donor to the hydrogen bond acceptor is (1:11)-(11:1); and the addition amount of the water accounts for 0-80% of the total mass.

As a preferable solution of the preparation method for the cellulose-based texture modifier and stabilizing agent extracted with the deep eutectic solvent, the cellulose raw material is a cellulose-based biomass raw material with a cellulose content greater than 20%, and includes one or more of pretreated straw, sugarcane bagasse, wood powder, corncob, fruit peel and plant leaves and stems;
the pretreatment comprises crushing, sieving, high-pressure steam explosion, microwave pretreatment, hot water pretreatment, lignin peroxidase or laccase pretreatment and acid pretreatment.

As a preferable solution of the preparation method for the cellulose-based texture modifier and stabilizing agent extracted with the deep eutectic solvent, the temperature of the heating extraction is 30-300° C. the extraction time is 0.1-480 h, and the mass ratio of the cellulose raw material to the deep eutectic solvent is (1:100)-(2:1).

As a preferable solution of the preparation method for the cellulose-based texture modifier and stabilizing agent extracted with the deep eutectic solvent, the temperature of the heating extraction is 50-150 DEG C, the extraction time is 0.5-48 h, and the mass ratio of the cellulose raw material to the deep eutectic solvent is 1:10.

As a preferable solution of the preparation method for the cellulose-based texture modifier and stabilizing agent extracted with the deep eutectic solvent, the method of defibering includes one or more of ultrasound, microwave, homogenization, emulsification and grinding.

As a preferable solution of the preparation method for the cellulose-based texture modifier and stabilizing agent extracted with the deep eutectic solvent, the method of drying includes one or more of roller drying, spray drying, freeze drying and microwave drying.

As a preferable solution of the preparation method for the cellulose-based texture modifier and stabilizing agent extracted with the deep eutectic solvent, in the spray drying, the mass ratio of a drying aid to the cellulose-based texture modifier and stabilizing agent is (0:1)-(10:1).

Another purpose of the present invention is to overcome disadvantages of the prior art, and provides a cellulose-based texture modifier and stabilizing agent extracted with a deep eutectic solvent, including,
20-100% of cellulose, 0-50% of lignin, 0-20% pf hemicellulose, 0-5% of ash content and 0-50% of other polysaccharides.

The third purpose of the present invention is to overcome the disadvantages of the prior art, and provides an application of the cellulose-based texture modifier and stabilizing agent extracted with the deep eutectic solvent, the viscosity of the cellulose-based texture modifier and stabilizing agent is 39.6-235 Pas; and the cellulose-based texture modifier and stabilizing agent can also be compounded with other polysaccharides or colloids to enhance the application effect.

The present invention has the beneficial effects that:
(1) The deep eutectic solvent selected in the present invention is specific. The principle of the action on cellulose-based biomass is as follows: one is to break the chemical bonds and hydrogen bond connections between some cellulose, hemicellulose and lignin, and remove most hemicellulose and a small amount of lignin; and the other is to break the hydrogen bonds between cellulose molecules, so as to defiber the cellulose and expose more fine fibers. After the fine fibers are fully hydrated, a hydrogen bond network can be formed to provide viscosity.
(2) The preparation method for the cellulose-based texture modifier and stabilizing agent extracted with the deep eutectic solvent in the present invention has low requirements for the consistency of raw materials, has a defibering effect on both long fibers and fine fibers, and can also play effects under the condition of a wide particle size range, therefore, having universality in the comprehensive utilization of cellulose-based biomass.
(3) The preparation method for the cellulose-based texture modifier and stabilizing agent extracted with the deep eutectic solvent is simple and feasible, and can efficiently defiber cellulose in the presence of lignin, thus avoiding the pollution that may be caused by other chemical methods when removing lignin, and having better environmental protection.
(4) Due to use of drying aids in the present invention, the drying yield can be increased, and the cost can be reduced.
(5) The deep eutectic solvent in the present invention is recyclable, is low in cost and has good economic benefits.

### BRIEF DESCRIPTION OF DRAWINGS

In order to describe the technical solutions in the embodiments of the present invention more clearly, a brief description of the accompanying drawings required for describing the embodiments will be provided below. Obviously, the accompanying drawings in the following description show merely some embodiments of the present invention. Those of ordinary skill in the art can also derive other accompanying drawings from these accompanying drawings without making creative efforts. In the figures:

FIG. 1 is an SEM image (A) and a partial enlarged drawing (B) of a bagasse raw material of Embodiment 1 of the present invention;

FIG. 2 is an AFM image of a cellulose-based texture modifier and stabilizing agent after extraction in Embodiment 1 of the present invention, wherein the scanning range of (A) is 10 μm, the scanning range of (B) is 3 μm, and the scanning range of (C) is 1 μm;

FIG. 3 are images of cellulose-based texture modifier and stabilizing agents prepared in Embodiment 1 of the present invention after rehydration with different concentrations;

FIG. 4 is a comparison diagram of viscosities of a cellulose-based texture modifier and stabilizing agent prepared in Embodiment 1 with other commercialized texture modifier and stabilizing agents in the present invention;

FIG. 5 is a comparison diagram of fiber particle sizes of Embodiment 1 and Embodiment 6 of the present invention;

FIG. 6 is an application effect in suspension support and emulsification stabilizing in Embodiment 1 of the present invention;

FIG. 7 are images of a cellulose-based texture modifier and stabilizing agent after solvent dispersion in Embodiments 7-9 and apparent viscosity test results; and

FIG. 8 is a comparison diagram of fiber particle sizes (A) of Embodiment 15 with comparative embodiment 9 and appearances (B) of comparative embodiment 9.

### DETAILED DESCRIPTION OF THE EMBODIMENTS

To make the aforementioned objectives, features and advantages of the present invention more apparent and comprehensible, the specific embodiments of the present invention are described in detail below with reference to the embodiments of the specification.

In the following description, numerous specific details are set forth to provide a thorough understanding of the present disclosure. However, the present disclosure can also be implemented in other ways than those described herein. Those skilled in the art can make similar generalization without departing from the essence of the present disclosure. Therefore, the present disclosure is not limited by the specific embodiments disclosed below.

Secondly, reference herein to “an example” or “embodiment” means a specific feature, structure, or characteristic that can be included in at least one embodiment of the present disclosure. Wherever the phrase “in one embodiment” appears in the specification, it does not necessarily refer to the same embodiment, nor does it imply that the embodiment is separate or mutually exclusive from other embodiments.

The raw materials used in the present invention, unless otherwise specified, are all common commercially available ones.

Performances of the material prepared in embodiments of the present invention are determined by the following methods:

Determination of component contents: determined with methods with the reference of NY/T 3494-2019 Determination of Cellulose, Hemicellulose and Lignin in Agricultural Biomass Raw Materials.

Determination with scanning electron microscopy (SEM): A bagasse raw material used in Embodiments 1-6 are fixed on a cross-section sample table with a conductive adhesive, fully purged and sprayed with gold, and photographed under a scanning electron microscope (SU8220, Hitachi, Japan). The accelerated voltage of the scanned sample is 3 kV. A cellulose-based texture modifier and stabilizing agent obtained in comparative embodiment 1 is rehydrated and dripped onto a silicon wafer, dried at room temperature, sprayed with gold, and photographed under a scanning electron microscope (SU8220, Hitachi, Japan). The accelerated voltage of the scanned sample is the same as 3 kV.

Determination with atomic force microscopy (AFM): After diluted to 50 mg/L, 10 μL of a fiber sample is dropped onto a mica sheet and observed under an atomic force microscope (Dimension FastScan, Bruker, Germany). Images are processed and analyzed with NanoScope Analysis 1.7.

Determination of particle size: The fiber particle size is determined with a laser particle size analyzer (Bettersize 2600, Dandong, China) in wet mode. A fiber with 0.25% mass concentration is dripped into a sample cell, and the particle size of the sample is determined after the shading is in the detection range of 8-15%.

Determination of viscosity (viscosimeter method): A sample of a cellulose-based agent with a mass concentration of 0.25% is prepared. After 180 MPa high-pressure homogenization for twice, the viscosity of each sample at a mass concentration of 0.25% is detemrined using a rapid viscometer (Brookfield DV2T, Bolefei, USA). The test conditions are: No. 13 rotor, rotation speed of 60 rpm.

Determination of viscosity (rheometer method): A sample of a cellulose-based agent with a mass concentration of 0.25% is prepared. After 180 MPa high-pressure homogenization for twice, 1 mL-2 mL of the sample is loaded on a rotary rheometer test bench (Discovery DHR-3, T.A., USA). Cone plates of 40 mm and 2 degrees are selected, with a gap value of 1,000 μm. The shear viscosity test program is: the apparent viscosity is tested under a shear rate of 0.001-1000/s at 25 DEG C, and the zero shear viscosity is fitted by a Carreau-Yasuda model.

### Embodiment 1

The embodiment provides a preparation method of a cellulose-based texture modifier and stabilizing agent, specifically:
(1) Preparation of a deep eutectic solvent: 126 g of dihydrate oxalic acid and 139.5 g of choline chloride were stirred for 2 h at 80 DEG C, so as to obtain a clarified transparent deep eutectic solvent, namely the mole ratio of a hydrogen bond donor to a hydrogen bond acceptor was 1:1, and the content of water in the deep eutectic solvent was 13.5%.
(2) Pretreatment of a cellulose-based biomass raw material: bagasse was crushed and sieved with 60 meshes.
(3) Extraction of a cellulose-based texture modifier and stabilizing agent: 100 g of the deep eutectic solvent and 10 g of the bagasse were mixed, and stirred to extract for 4 h at 70 DEG C.
(4) Filter pressing and washing: the bagasse after extraction was separated from the deep eutectic solvent through filter pressing, and the obtained bagasse extract was washed with clean water till the pH value of the filtrate was greater than 5.
(5) Defibering: the bagasse extract was homogenized at a high pressure of 180 MPa.
(6) Drying: the bagasse fiber obtained in (5) was treated with spray drying, the inlet air temperature was 180 DEG C, the outlet air temperature was 65 DEG C, the flow speed was adjusted according to the outlet air temperature, and pelleting was performed, to prepare the cellulose-based texture modifier and stabilizing agent.

### Comparative Example 1

The difference of the embodiment from Embodiment 1 lies in that the mole ratio of the hydrogen bond donor to the hydrogen bond acceptor is 1:11, and other preparation processes are the same as those of Embodiment 1, to prepare the cellulose-based texture modifier and stabilizing agent.

### Comparative Example 2

The difference of the embodiment from Embodiment 1 lies in that the mole ratio of the hydrogen bond donor to the hydrogen bond acceptor is 11:1, and other preparation processes are the same as those of Embodiment 1, to prepare the cellulose-based texture modifier and stabilizing agent.

Performances of the materials prepared in the embodiments and comparative embodiments are tested, and the comparison result with Embodiment 1 is shown in Table 1.

TABLE 1

| | Mass of | Mass of | | | |
|---|---|---|---|---|---|
| | hydrogen bond | hydrogen bond | Mole | Zero shear | |
| | donor | acceptor | ratio | viscosity | |
| Embodiment 1 | 126 g | 139.5 g | 1:1 | 235 | Pa · s |
| Comparative | 126 g | 1534.5 g | 1:11 | 1.25 | Pa · s |
| example 1 | | | | | |
| Comparative | 1386 g | 139.5 g | 11:1 | 10.26 | Pa · s |
| example 2 | | | | | |

The table above shows that adjusting the ratio of the hydrogen bond donor to the hydrogen bond acceptor of raw materials has a significant effect on the performance of the cellulose-based texture modifier and stabilizing agent, since an appropriate ratio of the hydrogen bond donor to the hydrogen bond acceptor is required to form the deep eutectic solvent. When one component is excessive in amount, the other component does not have enough hydrogen bond acceptor/donor to pair with, resulting in an unstable structure of the solvent system and degraded defibering performance. According to the results of the table above, an optimal technical effect can be achieved when the mole ratio of the hydrogen bond donor to the hydrogen bond acceptor in the present invention is 1:1.

### Embodiment 2

The difference of the embodiment from Embodiment 1 lies in that the hydrogen bond donor is adjusted to an amino compound, namely urea, and other preparation processes are the same as those of Embodiment 1, to prepare the cellulose-based texture modifier and stabilizing agent.

### Embodiment 3

The difference of the embodiment from Embodiment 1 lies in that the hydrogen bond donor is adjusted to an alcohol, namely glycerol, and other preparation processes are the same as those of Embodiment 1, to prepare the cellulose-based texture modifier and stabilizing agent.

### Embodiment 4

The difference of the embodiment from Embodiment 1 lies in that the hydrogen bond donor is adjusted to another carboxylic acid compound, namely citric acid, and other preparation processes are the same as those of Embodiment 1, to prepare the cellulose-based texture modifier and stabilizing agent.

Performances of the material prepared in the embodiment are tested, and the comparison result with Embodiment 1 is shown in Table 2.

TABLE 2

| | | Zero shear | |
|---|---|---|---|
| | Hydrogen bond donor | viscosity | |
| Embodiment 1 | Oxalic acid (carboxylic acid compound) | 235 | Pa · s |
| Embodiment 2 | Urea (amino compound) | 39.6 | Pa · s |
| Embodiment 3 | Glycerol (alcohol) | 12.6 | Pa · s |
| Embodiment 4 | Citric acid (carboxylic acid compound) | 128 | Pa · s |

The table above shows that adjusting the type of hydrogen bond donors of raw materials has a significant effect on the performance of the cellulose-based texture modifier and stabilizing agent, since an acidic deep eutectic solvent has a higher hydrogen bond acidity than other types of deep eutectic solvents, and a better ability to break the hydrogen bonds between fiber molecules, and is not prone to directly hydrolyze or dissolve crystalline cellulose, thus having a higher retention of cellulose. According to the results of the table above, an optimal technical effect can be achieved when the hydrogen bond donor in the present invention is a carboxylic acid compound.

### Embodiment 5

The difference of the embodiment from Embodiment 1 lies in that the content of water in the deep eutectic solvent is adjusted to 0 with anhydrous oxalic acid, and other preparation processes are the same as those of Embodiment 1, to prepare the cellulose-based texture modifier and stabilizing agent.

### Embodiment 6

The difference of the embodiment from Embodiment 1 lies in that the content of water in the deep eutectic solvent is adjusted to 80%, the extraction temperature is 100 DEG C, the extraction time is 5 h, and other preparation processes are the same as those of Embodiment 1, to prepare the cellulose-based texture modifier and stabilizing agent.

### Comparative Example 3

The difference of the embodiment from Embodiment 1 lies in that the content of water in the deep eutectic solvent is adjusted to 80%, and other preparation processes are the same as those of Embodiment 1, to prepare the cellulose-based texture modifier and stabilizing agent.

### Comparative Example 4

The difference of the embodiment from Embodiment 1 lies in that the content of water in the deep eutectic solvent is adjusted to 90%, the extraction temperature is 110 DEG C, the extraction time is 6 h, and other preparation processes are the same as those of Embodiment 1, to prepare the cellulose-based texture modifier and stabilizing agent.

Performances of the materials prepared in the embodiments and comparative embodiments are tested, and the comparison result with Embodiment 1 is shown in Table 3.

TABLE 3

| | Content | Extraction | | | Zero shear | |
|---|---|---|---|---|---|---|
| | of water | temperature | | Time | viscosity | |
| Embodiment 1 | 13.5% | 70 | DEG C | 4 h | 235 | Pa · s |
| Embodiment 5 | 0 | 70 | DEG C | 4 h | 159 | Pa · s |
| Embodiment 6 | 80% | 100 | DEG C | 5 h | 165.2 | Pa · s |
| Comparative | 80% | 70 | DEG C | 4 h | 0.49 | Pa · s |
| example 3 | | | | | | |
| Comparative | 90% | 110 | DEG C | 6 h | 1.56 | Pa · s |
| example 4 | | | | | | |

The table above shows that adjusting the content of water in the deep eutectic solvent has a significant effect on the performance of the cellulose-based texture modifier and stabilizing agent, since water can change critical indicators of viscosity, solvent polarity, hydrogen bond acidity, hydrogen bond alkalinity and the like, and an appropriate amount of water can reduce the viscosity of the deep eutectic solvent and promote the defibering process. Within a certain water content (water content of 80% in Embodiment 6), the defibering effect can be ensured by increasing the treatment temperature or prolonging the treatment time. When the water content exceeds 80%, a deep eutectic system composed of the hydrogen bond donor and the hydrogen bond acceptor can be destroyed, resulting in a degradation of the extraction effect. According to the results of the table above, an optimal technical effect can be achieved when the content of water in the deep eutectic solvent in the present invention is 0-80%.

### Embodiment 7

The difference of the embodiment from Embodiment 1 lies in that the cellulose raw material is adjusted to pineapple leaves, and other preparation processes are the same as those of Embodiment 1, to prepare the cellulose-based texture modifier and stabilizing agent.

### Embodiment 8

The difference of the embodiment from Embodiment 1 lies in that the cellulose raw material is adjusted to corncobs, and other preparation processes are the same as those of Embodiment 1, to prepare the cellulose-based texture modifier and stabilizing agent.

### Embodiment 9

The difference of the embodiment from Embodiment 1 lies in that the cellulose raw material is adjusted to carrot pomace, and other preparation processes are the same as those of Embodiment 1, to prepare the cellulose-based texture modifier and stabilizing agent.

### Comparative Example 5

The difference of the embodiment from Embodiment 1 lies in that the cellulose raw material is adjusted to coffee grounds, and other preparation processes are the same as those of Embodiment 1, to prepare the cellulose-based texture modifier and stabilizing agent.

Performances of the materials prepared in the embodiments and comparative embodiments are tested, and the comparison result with Embodiment 1 is shown in Table 4.

TABLE 4

| | Content of raw | | Zero shear | |
|---|---|---|---|---|
| | material cellulose | Raw material | viscosity | |
| Embodiment 1 | 39.4% | Bagasse | 235 | Pa · s |
| Embodiment 7 | 70.2% | Pineapple leaf | 127 | Pa · s |
| Embodiment 8 | 34.1% | Corncob | 226 | Pa · s |
| Embodiment 9 | 69.1% | Carrot pomace | 104 | Pa · s |
| Comparative | 20.0% | Coffee ground | 0.75 | Pa · s |
| example 5 | | | | |

The table above shows that adjusting the cellulose raw material of the raw materials has a significant effect on the performance of the cellulose-based texture modifier and stabilizing agent, since coffee ground has a less content of cellulose than other raw materials, the content of hemicellulose and lignin accounts for about more than 60% of the dry weight, and cellulose only accounts for 20%, so that the texture modifier and stabilizing agent after extraction is insufficient in cellulose content, and a hydrogen bond network is hard to form in water. According to the results of the table above, an optimal technical effect can be achieved when a cellulose raw material that the cellulose content in scraps is greater than 20% is used.

### Comparative Example 6

The difference of the embodiment from Embodiment 1 lies in that the heating extraction temperature is adjusted to 50 DEG C, and other preparation processes are the same as those of Embodiment 1, to prepare the cellulose-based texture modifier and stabilizing agent.

### Embodiment 10

The difference of the embodiment from Embodiment 1 lies in that the heating extraction temperature is adjusted to 50 DEG C, the heating extraction time is 24 h, and other preparation processes are the same as those of Embodiment 1, to prepare the cellulose-based texture modifier and stabilizing agent.

### Comparative Example 7

The difference of the embodiment from Embodiment 1 lies in that the heating extraction temperature is adjusted to 150 DEG C, and other preparation processes are the same as those of Embodiment 1, to prepare the cellulose-based texture modifier and stabilizing agent.

### Embodiment 11

The difference of the embodiment from Embodiment 1 lies in that the heating extraction temperature is adjusted to 150 DEG C, the heating extraction time is 0.5 h, and other preparation processes are the same as those of Embodiment 1, to prepare the cellulose-based texture modifier and stabilizing agent.

### Comparative Example 8

The difference of the embodiment from Embodiment 1 lies in that the heating extraction time is adjusted to 0.5 h, and other preparation processes are the same as those of Embodiment 1, to prepare the cellulose-based texture modifier and stabilizing agent.

### Embodiment 12

The difference of the embodiment from Embodiment 1 lies in that the heating extraction time is adjusted to 48 h, and other preparation processes are the same as those of Embodiment 1, to prepare the cellulose-based texture modifier and stabilizing agent.

Performances of the materials prepared in the embodiments and comparative embodiments are tested, and the comparison result with Embodiment 1 is shown in Table 5.

TABLE 5

| | Extraction | | Extraction | | Zero shear | | |
|---|---|---|---|---|---|---|---|
| | temperature | | time | | viscosity | | Color |
| Embodiment 1 | 70° | C. | 4 | h | 235 | Pa · s | Light yellow |
| Comparative | 50° | C. | 4 | h | 0.11 | Pa · s | Light yellow |
| example 6 | | | | | | | |
| Embodiment 10 | 50° | C. | 24 | h | 181 | Pa · s | Light yellow |
| Comparative | 150° | C. | 4 | h | 10.5 | Pa · s | Black |
| example 7 | | | | | | | |
| Embodiment 11 | 150° | C. | 0.5 | h | 126 | Pa · s | Light yellow |
| Comparative | 70° | C. | 0.5 | h | 0.25 | Pa · s | Light yellow |
| example 8 | | | | | | | |
| Embodiment 12 | 70° | C. | 48 | h | 66.5 | Pa · s | Black |

When the extraction temperature is too low or the extraction time is short, the degree of cellulose defibering is not enough, and high viscosity hydrocolloids cannot be formed. When the extraction temperature is too high or the time is too long, the cellulose is excessively hydrolyzed, then the radius of fluid mechanics is reduced and the viscosity is reduced. The structure of lignin is depolymerized and condensed, then the color is deepened, and the application is limited. According to the results of the table above, an optimal technical effect can be achieved in an optimal heating extraction temperature range of 50-150 DEG C and an extraction time range of 0.5-48 h.

### Embodiment 13

The difference of the embodiment from Embodiment 1 lies in that the step (6) is adjusted, that the cellulose-based texture modifier and stabilizing agent is mixed with 0.5 part of pectin and treated with spray drying, and other preparation processes are the same as those of Embodiment 1, to prepare the cellulose-based texture modifier and stabilizing agent.

### Embodiment 14

The difference of the embodiment from Embodiment 1 lies in that the step (6) is adjusted, that the cellulose-based texture modifier and stabilizing agent is mixed with 0.5 part of maltodextrin and 0.5 part of pectin and treated with spray drying, and other preparation processes are the same as those of Embodiment 1, to prepare the cellulose-based texture modifier and stabilizing agent.

### Embodiment 15

In the embodiment, a deep eutectic solvent obtained through filter pressing is recycled for further use, to prepare the cellulose-based texture modifier and stabilizing agent. Specifically:
(1) Preparation of the deep eutectic solvent: 126 parts of oxalic acid and 139.5 parts of choline chloride were stirred for 2 h at 80 DEG C, to obtain a clarified transparent deep eutectic solvent.
(2) Pretreatment of a cellulose-based biomass raw material: bagasse was treated with steam explosion for 5 min in a reaction kettle of 200 DEG C with the pressure of 5 Mpa, and crushed and sieved for 60 meshes.
(3) Extraction of a cellulose-based texture modifier and stabilizing agent: 100 parts of the deep eutectic solvent prepared in (1) was mixed with 10 parts of bagasse, and stirred to extract for 4 h at 70 DEG C.
(4) Filter pressing and washing: the bagasse after extraction was separated from the deep eutectic solvent through filter pressing, to obtain the recycled deep eutectic solvent.
(5) Extraction of a cellulose-based texture modifier and stabilizing agent: 100 parts of the recycled deep eutectic solvent obtained in (4) and 10 parts of the pretreated bagasse obtained in (2) were mixed, and stirred to extract for 4 h at 70 DEG C.
(6) Filter pressing and washing: the bagasse after extraction was separated from the deep eutectic solvent through filter pressing, and the obtained bagasse extract was washed with clean water till the pH value of the filtrate was greater than 5.
(7) Defibering: the bagasse extract prepared in (6) was homogenized at a high pressure of 180 MPa.
(8) Drying: the bagasse extract obtained in (7) was treated with spray drying, the inlet air temperature was 180 DEG C, the outlet air temperature was 60-70 DEG C, the flow speed was adjusted according to the outlet air temperature, and pelleting was performed, to prepare the cellulose-based texture modifier and stabilizing agent.

Performances of the material prepared in the embodiment are tested, and the comparison result with Embodiment 1 is shown in Table 6.

TABLE 6

| | Rehydration | | |
|---|---|---|---|
| | condition | Zero shear viscosity | Yield |
| Embodiment 1 | Homogenization for | 235 Pa · s | 50% |
| | twice at 180 MPa | | |
| Embodiment 13 | Homogenization for | 202 Pa · s | 71% |
| | once at 150 MPa | | |
| Embodiment 14 | Homogenization for | 218 Pa · s | 98% |
| | once at 150 MPa | | |
| Embodiment 15 | Homogenization for | 221 Pa · s | 50% |
| | twice at 180 MPa | | |

Note: the yield of the cellulose-based texture modifier and stabilizing agent needs to be tested only when the drying mode is spray drying, and the yield of other drying modes is all 100%.

The table above shows that when the cellulose-based texture modifier and stabilizing agent is dried after compounded with other polysaccharides, the homogenization pressure and times required in rehydration can be reduced, since other polysaccharides enhance the dispersibility of cellulose-based colloids. The drying yield can be remarkably increased when the prepared cellulose-based texture modifier and stabilizing agent is compounded with a drying aid. That to enhance the dispersibility and increase the drying yield, the cellulose in the present invention is compounded with other colloids and drying aids shall be included in the protection scope of the present invention. In the cellulose extraction process, a sample after sufficient homogenization treatment has a good effect, and no matter whether a drying step is included, shall be included in the protection scope of the present invention. The recycling effect of the deep eutectic solvent can be ensured by pretreating raw materials to remove a part of hemicellulose or non-crystalline cellulose, and acid-soluble lignin. Cellulose-based texture modifier and stabilizing agents prepared from raw materials through various pretreatment methods and then extraction with the deep eutectic solvent shall also be included in the protection scope of the present invention.

### Comparative Example 9

(1) Pretreatment of a cellulose-based biomass raw material: bagasse was treated with steam explosion for 5 min in a reaction kettle of 200 DEG C with the pressure of 5 Mpa, and crushed and sieved for 60 meshes
(2) Extraction of a cellulose-based texture modifier and stabilizing agent: 10 parts of the bagasse prepared in (1) was mixed with 100 parts of water, and stirred for 4 h at 70 DEG C.
(3) Filter pressing and washing: the bagasse after extraction in (2) was separated from water through filter pressing, and the obtained bagasse extract was washed with clean water till the pH value of the filtrate is 5-9.
(4) Defibering: the bagasse extract prepared in (3) was homogenized at a high pressure of 180 MPa.
(5) Drying: the bagasse fiber obtained in (4) was treated with spray drying, the inlet air temperature was 180 DEG C, the outlet air temperature was 60-70 DEG C, the flow speed was adjusted according to the outlet air temperature, and pelleting was performed, to prepare the cellulose-based texture modifier and stabilizing agent as a comparative embodiment.

### Comparative Example 10

(1) Preparation of a deep eutectic solvent: 126 g of dihydrate oxalic acid and 139.5 g of choline chloride were stirred for 2 h at 80 DEG C, so as to obtain a clarified transparent deep eutectic solvent, namely the mole ratio of a hydrogen bond donor to a hydrogen bond acceptor was 1.4:1.
(2) Extraction of a cellulose-based texture modifier and stabilizing agent: 100 g of the deep eutectic solvent and 10 g of untreated bagasse were mixed, and stirred to extract for 4 h at 70 DEG C.
(3) Filter pressing and washing: the bagasse after extraction was separated from the deep eutectic solvent through filter pressing, and the obtained bagasse extract was washed with clean water till the pH value of the filtrate was greater than 5.
(4) Defibering: the bagasse extract was dispersed with ultrasound dispersion at 600 W for 30 min.
(5) Drying: the bagasse fiber obtained in (4) was treated with spray drying, the inlet air temperature was 180 DEG C, the outlet air temperature was 65 DEG C, the flow speed was adjusted according to the outlet air temperature, and pelleting was performed, to prepare the cellulose-based texture modifier and stabilizing agent.

Performances of the material prepared in the comparative embodiments are tested, and the comparison result with Embodiment 1 is shown in Table 7.

TABLE 7

| | Zero shear viscosity | |
|---|---|---|
| Embodiment 1 | 235 | Pa · s |
| Comparative example 9 | 0.05 | Pa · s |
| Comparative example 10 | 0.15 | Pa · s |

The table above shows that the bagasse, which is only subjected to crushing and sieving and pretreatment of steam explosion, but not extracted with the deep eutectic solvent, is low in cellulose viscosity, the texture modifying cannot be achieved, since the cellulose cannot be sufficient defibered in the pretreatment, no sufficient hydroxy participates in hydration, and no hydrogen bond network can be formed to enhance the viscosity. For some materials with good hydrogen bond connections in cellulose molecules, the deep eutectic solvent is in poor contact accessibility with materials without pretreatment such as crushing and sieving, resulting in a poor treatment effect.

The contents of components of the cellulose-based texture modifier and stabilizing agent prepared in the embodiments and comparative embodiments above are tested, and the results are shown in Table 8.

TABLE 8

| | Content of | Hemicellulose | Cellulose | |
|---|---|---|---|---|
| | lignin | content | content | Content of ash |
| Bagasse | 27.4 ± 1.2% | 26.8 ± 1.8% | 39.4 ± 2.6% | 3.53 ± 0.12% |
| Embodiment 1 | 32.2 ± 2.4% | 6.15 ± 0.53% | 56.0 ± 1.9% | 2.92 ± 0.25% |
| Embodiment 2 | 48.2 ± 1.6% | 4.10 ± 1.15% | 45.9 ± 1.8% | 3.25 ± 0.21% |
| Embodiment 4 | 33.2 ± 1.8% | 5.30 ± 0.51% | 55.2 ± 2.3% | 3.25 ± 0.36% |
| Embodiment 15 | 33.8 ± 2.5% | 2.15 ± 0.5% | 58.1 ± 1.6% | 3.10 ± 0.22% |
| Comparative | 36.8 ± 1.5% | 4.75 ± 0.55% | 55.4 ± 1.1% | 2.92 ± 0.25% |
| embodiment 9 | | | | |

The table above shows that the treatment methods in Embodiments 1-6 and comparative embodiment 9 can both remove hemicellulose, but are poor in the lignin removing effect. The deep eutectic solvents in Embodiments 1 and 4 with carboxylic acid as the hydrogen bond donor have the similar retention rate for components. However, the deep eutectic solvent used in Embodiment 2 has a remarkably reduced retention rate for cellulose. In Embodiment 15, pretreatment of steam explosion of the bagasse raw material is added, thus achieving a good hemicellulose removing effect. The comparative embodiment 9 further explains that although steam explosion can remove hemicellulose to obtain composition of components similar to those of Embodiment 1, the viscosity increasing effect is poor since the cellulose is not defibered with the deep eutectic solvent.

FIG. 1 is an SEM image (A) and a partial enlarged drawing (B) of the bagasse raw material used in Embodiment 1, showing a poor bagasse fiber consistency, which is mainly caused by cellular structural characteristics and the presence of bagasse pith in the growing process of sugarcane.

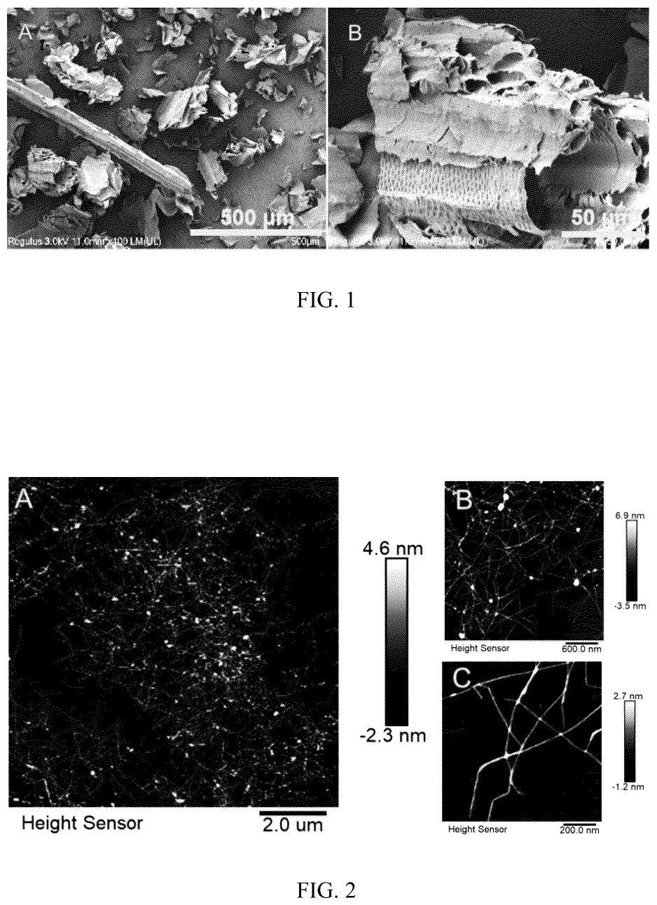

FIG. 2 is an AFM image of a cellulose-based texture modifier and stabilizing agent after extraction in Embodiment 1. FIG. 2 shows that the cellulose in Embodiment 1 is defibered into fine fibers of 4-10 nm, and linking of fine fibers is not broken. Data of component contents of bagasse shown in Table 8 and the cellulose-based texture modifier and stabilizing agent prepared in Embodiment 1, show that it may be an unremoved lignin-carbohydrate compound that links the fine fibers. Most hemicellulose in bagasse is removed in the treatment process of Embodiment 1, and most lignin is retained. A defibered nanofiber can provide sufficient hydrogen bond hydration to form the hydrogen bond network. However, lignin retained in situ plays a role of linking, providing a large hydromechanic radius.

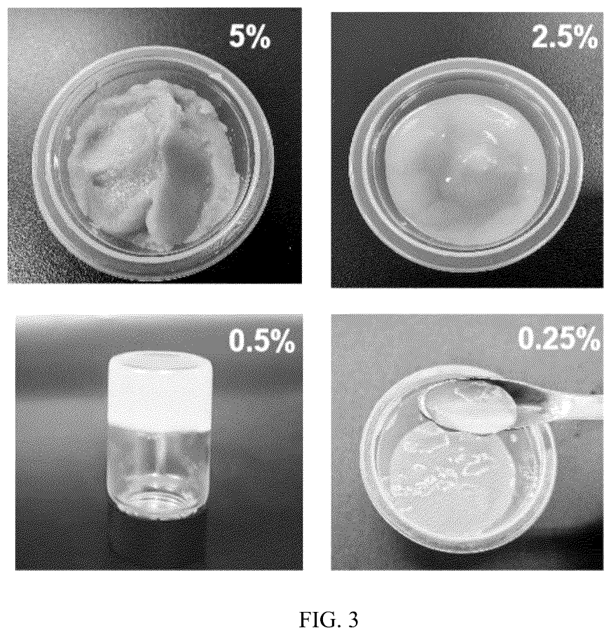

FIG. 3 are images of cellulose-based texture modifier and stabilizing agents prepared in Embodiment 1 after rehydration with different concentrations. FIG. 3 shows that the cellulose-based texture modifier and stabilizing agent obtained in Embodiment 1 with the concentration of 2.5-5% can form a semisolid with a high water binding capacity after sufficient shearing, can form a stable gel with the concentration of 0.5%, and can form a high-viscosity dispersion liquid which is relatively transparent and has a certain gel property with the concentration of 0.25%.

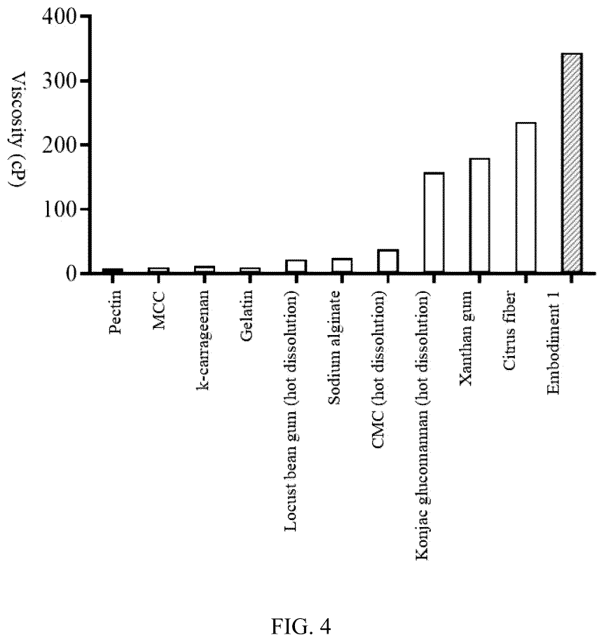

FIG. 4 is a comparison diagram of viscosities of a cellulose-based texture modifier and stabilizing agent prepared in Embodiment 1 with other commercialized texture modifier and stabilizing agents in the present invention. FIG. 4 shows that the cellulose-based texture modifier and stabilizing agent prepared in Embodiment 1 has a better viscosity than those of multiple commercialized texture modifier and stabilizing agents with the same concentration.

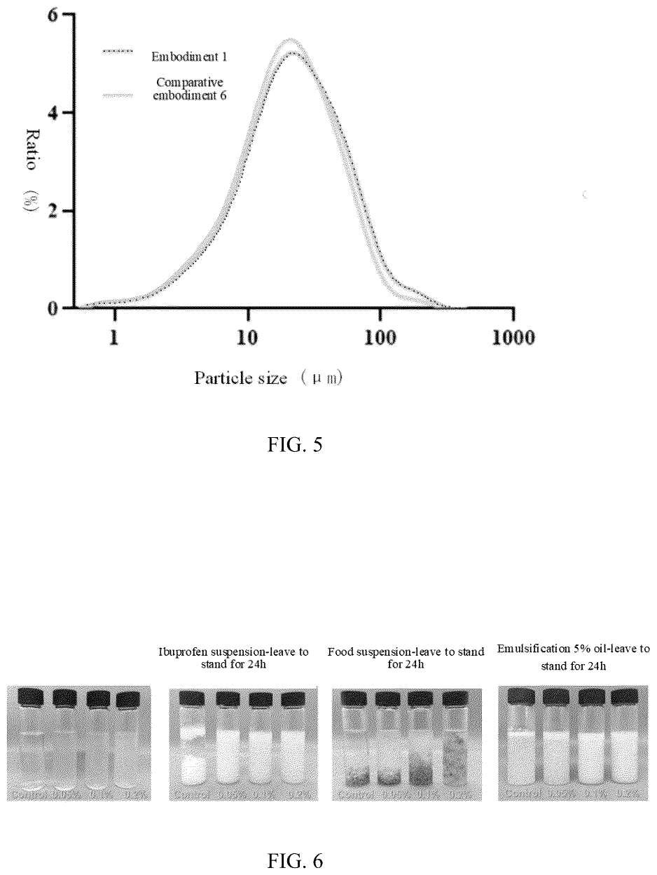

FIG. 5 is a comparison diagram of fiber particle sizes of Embodiment 1 and Embodiment 6 of the present invention. FIG. 5 shows that by adjusting the treatment temperature and time, a deep eutectic solvent with a high water content can achieve a defibering effect similar to that of a deep eutectic solvent of a low water content, thereby obtaining a cellulose-based texture modifier and stabilizing agent of the same defibering degree.

FIG. 6 is an application effect of the texture modifier and stabilizing agent prepared in Embodiment 1. Good performance in suspension support and emulsification stabilizing is achieved.

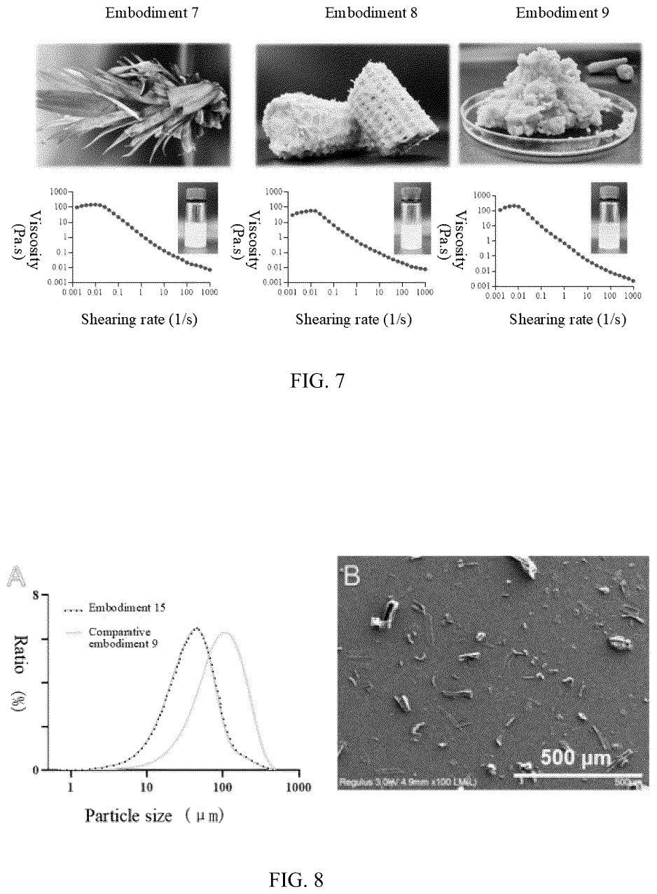

FIG. 7 are images of a cellulose-based texture modifier and stabilizing agent after solvent dispersion in Embodiments 7-9 and apparent viscosity test results. FIG. 7 shows that the method for the cellulose-based texture modifier and stabilizing agent extracted with the deep eutectic solvent in the present invention has universality in biomass treatment.

FIG. 8 is a comparison diagram of fiber particle sizes (A in FIG. 8) of Embodiment 15 with comparative embodiment 9 and appearances (B in FIG. 8) of comparative embodiment 9. Results of FIG. 8, Table 6 and Table 7 show that compared with extraction with pure steam explosion in comparative embodiment 9, treatment with the deep eutectic solvent in Embodiment 15 is the key to a high viscosity and a high defibering degree.

In summary, the preparation method for the cellulose-based texture modifier and stabilizing agent extracted with the deep eutectic solvent in the present invention has low requirements for the consistency of raw materials, has a defibering effect on both long fibers and fine fibers, and can also play effects under the condition of a wide particle size range, therefore, having universality in the comprehensive utilization of cellulose-based biomass. The method is simple and feasible, and can efficiently defiber cellulose in the presence of lignin, thus avoiding the pollution that may be caused by other chemical methods when removing lignin, and having better environmental protection.

It should be noted that the above embodiments are merely used to explain the technical solutions of the present disclosure and not intended to limit the present disclosure. Although the present disclosure is described in detail with reference to the preferred embodiments, those of ordinary skill in the art should understand that they can make modifications or equivalent substitutions to the technical solutions of the present disclosure without departing from the spirit and scope of the technical solutions of the present disclosure. These modifications or equivalent substitutions should fall within the scope of the claims of the present disclosure.

What is claimed is:

1. A preparation method for a cellulose-based texture modifier and stabilizing agent extracted with a deep eutectic solvent, comprising:
mixing a hydrogen bond donor, a hydrogen bond acceptor and water, and heating to prepare a deep eutectic solvent; mixing the deep eutectic solvent with a cellulose raw material, and performing heating extraction; and performing filter pressing, washing, suction filtration, defibering, and drying on the extracted cellulose raw material, thereby obtaining a cellulose-based texture modifier and stabilizing agent.

2. The preparation method for the cellulose-based texture modifier and stabilizing agent extracted with the deep eutectic solvent according to claim 1, wherein the hydrogen bond donor comprises one or more of amino compounds, polycarboxylic acids, polyhydric alcohol compounds or compounds with both amino groups and carboxyl groups; and the hydrogen bond acceptor comprises one or more of ammonium chloride, sodium chloride and choline chloride.

3. The preparation method for the cellulose-based texture modifier and stabilizing agent extracted with the deep eutectic solvent according to claim 2, wherein the amino compounds comprise urea; the polycarboxylic acids comprise acetic acid, oxalic acid, citric acid, tartaric acid, lactic acid, malic acid and phenylacetic acid; the polyhydric alcohol compounds comprise glycerol, glycol and propylene glycol; and the compounds with both amino groups and carboxyl groups comprise glycine and glutamic acid.

4. The preparation method for the cellulose-based texture modifier and stabilizing agent extracted with the deep eutectic solvent according to claim 2, wherein the mole ratio of the hydrogen bond donor to the hydrogen bond acceptor is (1:11)-(11:1); and the addition amount of the water accounts for 0-80% of the total mass of the deep eutectic solvent.

5. The preparation method for the cellulose-based texture modifier and stabilizing agent extracted with the deep eutectic solvent according to claim 1, wherein the cellulose raw material is a cellulose-based biomass raw material with a cellulose content greater than 20%, and comprises one or more of pretreated straw, sugarcane bagasse, wood powder, corncob, fruit peel and plant leaves and stems; and
the pretreatment comprises crushing, sieving, high-pressure steam explosion, microwave pretreatment, hot water pretreatment, lignin peroxidase or laccase pretreatment and acid pretreatment.

6. The preparation method for the cellulose-based texture modifier and stabilizing agent extracted with the deep eutectic solvent according to claim 1, wherein the temperature of the heating extraction is 30-300 DEG C, the extraction time is 0.1-480 h, and the mass ratio of the cellulose raw material to the deep eutectic solvent is (1:100)-(2:1).

7. The preparation method for the cellulose-based texture modifier and stabilizing agent extracted with the deep eutectic solvent according to claim 6, wherein the temperature of the heating extraction is 50-150 DEG C, the extraction time is 0.5-48 h, and the mass ratio of the cellulose raw material to the deep eutectic solvent is 1:10.

8. The preparation method for the cellulose-based texture modifier and stabilizing agent extracted with the deep eutectic solvent according to claim 1, wherein the method of defibering comprises one or more of ultrasound, microwave, homogenization, emulsification and grinding; and the method of drying comprises one or more of roller drying, spray drying, freeze drying and microwave drying.

9. A cellulose-based texture modifier and stabilizing agent extracted with the deep eutectic solvent prepared with the method according to claim 8, by weight percent, comprising:
20-100% of cellulose, 0-50% of lignin, 0-20% pf hemicellulose, 0-5% of ash content and 0-50% of other polysaccharides.

10. An application of the cellulose-based texture modifier and stabilizing agent extracted with the deep eutectic solvent according to claim 9, wherein the viscosity of the cellulose-based texture modifier and stabilizing agent is 39.6-235 Pa·s; and the cellulose-based texture modifier and stabilizing agent can also be compounded with other polysaccharides or colloids to enhance the application effect.
